(19) United States
(12) Patent Application Publication
(10) Pub. No.: US 2009/0073254 A1
(43) Pub. Date: Mar. 19, 2009

(54) OMNIDIRECTIONAL IMAGING SYSTEM WITH CONCURRENT ZOOM

(76) Inventors: Hui Li, North Potomac, MD (US); Jatinder Jatinder, Rockville, MD (US); Steven Yi, Vienna, VA (US)

Correspondence Address: STEVEN L. NICHOLS;RADER, FISHMAN & GRAUER PLLC, 10653 S. RIVER FRONT PARKWAY, SUITE 150, SOUTH JORDAN, UT, 84095, US

(21) Appl. No.: 11/856,516

(22) Filed: Sep. 17, 2007

(51) Int. Cl. H04N 7/00

(52) U.S. Cl. 348/36

(57) ABSTRACT

An optical system configured to simultaneously image an omnidirectional field-of-view and a concurrent narrow field on a single focal plane.

### BACKGROUND

There is a widespread need for a robust, inexpensive surveillance imaging system that provides omnidirectional imagery in conjunction with simultaneous zoom. Such an imaging system would provide continuous coverage of a 360° omnidirectional view while allowing the user to zoom in on a particular region of interest within the omnidirectional field-of-view.

Historically, it has been difficult to provide both an omnidirectional field of view while also having the ability to focus on a particular region of interest. For example, historical attempts have involved the coordinated use of two different imaging systems, one with a wide field of view to provide the general surveillance view and a second that can be specifically directed and focused within that field of view to provide more detailed imaging. However, there a clearly issues that arise with the expense of providing two such imaging system. There are also operational issues that arise in coordinating the output from the two cameras to accomplish the objectives of both wide surveillance viewing and detailed target imaging.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 illustrates an omnidirectional imaging system according to one illustrative embodiment.

FIG. 2 is a perspective diagram of an omnidirectional imaging system according to one illustrative embodiment.

FIG. 3 illustrates one illustrative embodiment of a focal plane with an annular image superimposed on the surface of the focal plane, according to principles described herein.

FIG. 4 illustrates one illustrative embodiment of a focal plane with an annular image and simultaneous narrow field-of-view superimposed on the surface of the focal plane, according to principles described herein.

FIG. 5 is a diagram of one illustrative embodiment of an omnidirectional imaging device with concurrent zoom, according to principles described herein.

FIG. 6 is a diagram of one illustrative embodiment of an omnidirectional imaging device with concurrent zoom, according to principles described herein.

FIG. 7 is a perspective view of one illustrative embodiment of a hyperbolic and pan/tilt mirror assembly, according to principles described herein.

FIG. 8 illustrates a simulated optical image generated by a hyperbolic and pan/tilt mirror assembly, according to principles described herein.

FIG. 9 illustrates one illustrative embodiment of processed images produced by the omnidirectional imaging device with concurrent zoom, according to principles described herein.

Throughout the drawings, identical reference numbers designate similar, but not necessarily identical, elements.

### DETAILED DESCRIPTION

In the United States, over one million surveillance cameras are installed. These surveillance cameras provide information that is critical for the operation of our society. For example, cameras provide law enforcement officers with information that leads to lower crime, fewer injuries, and quicker apprehension of violators. The government and private industry use surveillance cameras to protected perimeters, deter wrongdoing, control traffic, and for many other uses. The military uses surveillance to protect installations and to identify potential threats.

As used in this specification and appended claims “omnidirectional images” or “omnidirectional field-of-view” refers to images with a field-of-view which substantially covers an entire hemisphere (2 pi steradians of solid angle) simultaneously.

While there are many approaches that seek to achieve omnidirectional imaging through the use of a single camera, there are no single focal plane systems that obtain continuous omnidirectional imagery and with a concurrent zoom. As disclosed in the present specification, an imaging system that uses a single camera to provide continuous broad area surveillance with a concurrent zoom provides superior imagery and information. The continuous broad area view allows for panoramic sensing of potential threats in real time. The concurrent zoom allows a simultaneous detailed view of a region of interest within the omnidirectional field-of-view. With a concurrent zoom capability, threats can be more easily classified and tracked within the omnidirectional view.

There are systems currently available that provide broad area surveillance. For example, broad area surveillance can be performed by fisheye lenses, PAL converters, panning systems, or multiple cameras. However, each of these systems has deficiencies and none of the systems are capable of providing an omnidirectional view with a concurrent zoom view with a single focal plane.

Fisheye lenses are ultra wide angle lenses that provide hemispherical images. Fisheye lenses are large in size, complex in design, and expensive. The fisheye lens has the highest resolution in the center of the image and poor resolution along the circular periphery of the image. For many surveillance systems, objects that are imaged through the periphery of the lens, such as objects along the horizon, have significant importance. The fisheye lens provides the lowest resolution in these areas. Further, fisheye lenses, like all other very wide-angle lenses, suffer from large amount of chromatic aberration and radial distortion, particularly at the circular periphery of the image. This creates a distorted and imprecise representation of objects that are imaged through the periphery of the fisheye lens.

Additionally, fisheye lenses inefficiently use the light that enters the lens from the surroundings. To allow for an extremely wide field-of-view of fisheye lenses utilize multiple complex optical elements. This increases the number of refractive surfaces and transmissive volumes through which the light must pass. At each refractive or transmissive volume a portion of the light is lost. These losses reduce the amount of light that reaches the focal plane.

The multiple elements within a fisheye lens lead to a very high system cost. Each optical surface of these elements must be designed, machined, diamond turned, and coated for the particular wavelength region in which the fisheye system will operate.

Another wide angle imaging option is the use of a PAL converter. PAL converters are manufactured as accessories to matching imaging lenses. The PAL converter produces an annular image of the surrounding scene by placing two reflective surfaces and two refractive surfaces in front of the matching imaging lens. The light rays first enter the system and reflect off a first reflective surface, then reflect off the second reflective surface, and exit through the refractive surface thereby producing an annular image from a cylindrical field-of-view about the axis of symmetry that passes through the center of the lens system. PAL converter systems provide broad area coverage with the highest image resolution from being at the perimeter of the image. However, PAL converter systems are incapable of providing a simultaneous zoom view necessary to obtain detailed information about objects within the region of interest. Further, PAL converter systems are complex, bulky, and expensive. Like a fisheye system, a PAL converter system requires a large number of optical elements to direct the light to a focal plane. This results in an expensive system with low light throughput.

A straightforward method to increase the field-of-view of a surveillance system is to take multiple images with a single imaging system. The imaging system is rotated or panned about a center projection and a sequence of individual images are acquired at different angular positions. The images are stitched together to obtain a panoramic view of the scene. However, a panning camera is unable to provide continuous coverage of the surroundings because the camera must rotate away from one field-of-view to provide coverage of a second field of view. This restricts the use of panning systems to static and/or non real time applications.

A large field-of-view may be obtained by using multiple cameras, with each camera pointing in a different direction. However, it is difficult to seamlessly integrate multiple images from different cameras because every field-of-view is imaged by a camera with a different center projection. This often results in a disjointed view of the surveillance area. Because each camera has a different center of projection, there is considerable image processing required to obtain precise information on the position of an observed object or area of interest. Moreover, because multiple cameras are used, the size, the complexity, power consumption, and cost of such a system is usually high. The data acquisition system and image processing requirements also make a multiple camera systems very expensive.

To achieve broad area surveillance and a simultaneous narrow zoom field-of-view, two cameras can be used. For example, one camera could be used in a configuration that provides broad area surveillance while another camera could be used in a panning mode that provides zoom views of objects within a region of interest.

This configuration has the following disadvantages when compared with a single focal plane system: higher system cost, higher mechanical complexity, higher power requirements, under utilization of camera pixels. The two camera system has higher cost because the use of an extra camera with its accompanying imaging optics almost doubles the cost of the system. The two camera system has higher mechanical complexity because the mechanical structure must house and stabilize two optical subsystems. There must also be separate power and data connections for each camera. Two cameras consume greater power than a single camera system. Low power consumption is a critical factor for battery powered stand alone systems that are used in the field. Further, the two camera system under utilizes camera pixels that are available. As explained below, only a fraction of the pixels in the camera that generates the 360° omnidirectional view are used.

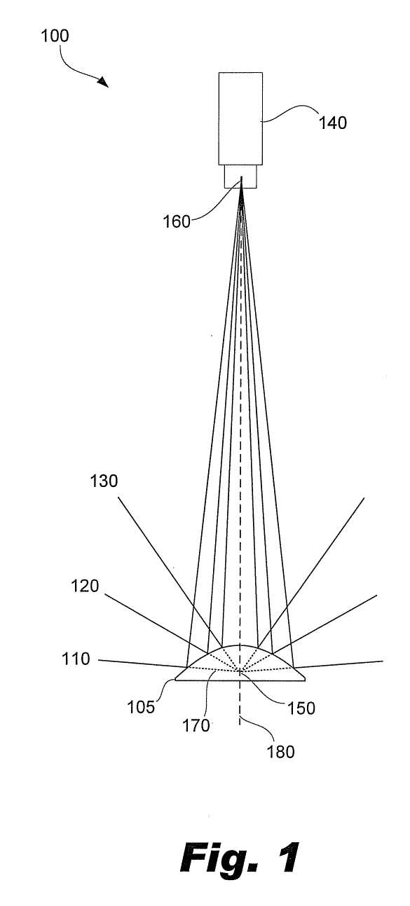

FIG. 1 shows an imaging system (100) that provides 360° omnidirectional image using a single camera (140). Systems of this type are further described in U.S. Pat. No. 6,774,569 which is hereby incorporated by reference in its entirety. The imaging system (100) of FIG. 1 shows a method of dramatically increasing the field-of-view of a conventional camera by employing a reflective mirror properly placed in front of the camera. In one illustrative embodiment, the reflective mirror is a substantially hyperbolic reflective mirror (105). The camera (140) has a lens system and focal plane configured such that the hyperbolic reflective mirror (105) falls within the field-of-view of the camera (140) and directs light from the surroundings into the camera aperture. The camera generates two-dimensional image data signals. These image data signals are conveyed to an image processor which manipulates the image data signals to produce the omnidirectional image. The image manipulation includes an “unwrapping” of the sensed image to allow a natural projection and display of the surroundings.

There are a number of surface profiles that can be used as a reflective mirror (105) to produce an omnidirectional field-of-view. These include segmented mirrors, conic mirrors, spherical mirrors, parabolic mirrors, and hyperbolic mirrors. Each mirror surface projects a compressed and distorted image onto the focal plane. In many instances, it is preferable to select a specific type of reflective mirror profile to preserve characteristics of the image. Important image characteristics include geometric correspondence and a single view point. A geometric correspondence requires that there be a one-to-one correspondence between pixels in an image and the points on the scene. The geometric correspondence allows the presentation of a coherent image with minimal data processing time. To have a single view point, each pixel in the image corresponds to a particular viewing direction defined by a ray from that pixel on the image plane through the single view point. Preserving a single view point minimizes distortion between segments of the images and allows rapid image processing that assumes linear perspective projection. Further, images taken from a single view point are desirable because the images have a natural perspective that is consistent with the way humans are accustom to viewing the world around us.

FIG. 1 illustrates an omnidirectional imaging assembly (100) that includes a reflective mirror (105) and an imaging device such as a video camera (140). The video camera (140) may be any suitable camera such as an off-the-shelf camera with a regular lens that has a field-of-view that covers substantially the entire surface of the reflective mirror (105). The off-the-shelf video camera and lenses are rotationally symmetric about an optical axis (180). To project a cylindrically uniform image onto the camera's focal plane, the reflective mirror (105) is then chosen to be a solid of revolution obtained by sweeping a cross-section about the optical axis (180) of the omnidirectional imaging assembly (100). In this case, a hyperbolic mirror surface was chosen. The function of the hyperbolic mirror (105) is to reflect the viewing rays (110, 120, and 130) emanating from objects within the field-of-view to the video camera's viewing center or focal point (160).

The hyperbolic mirror (105) preserves both the geometric correspondence and the single view point of the original image. The light is reflected such that all the incident portions of the light rays (110, 120, and 130) that reflect off of the reflective surface of the hyperbolic mirror (105) have projections (170) that extend toward a single virtual viewing point (150) at the focal center of the hyperbolic mirror (105). By using a hyperbolic profile for the reflective surface (105), all the extensions (170) pass through a single virtual viewing point (150). A video camera (140) is placed at the other focal point of the hyperbolic curve (160). This produces an image that has a single view point placed at the virtual viewpoint (150). In other words, the hyperbolic mirror (105) effectively steers the viewing rays (110,120, and 130) such that the camera (140) equivalently sees the objects in the world from the single virtual viewing point (150).

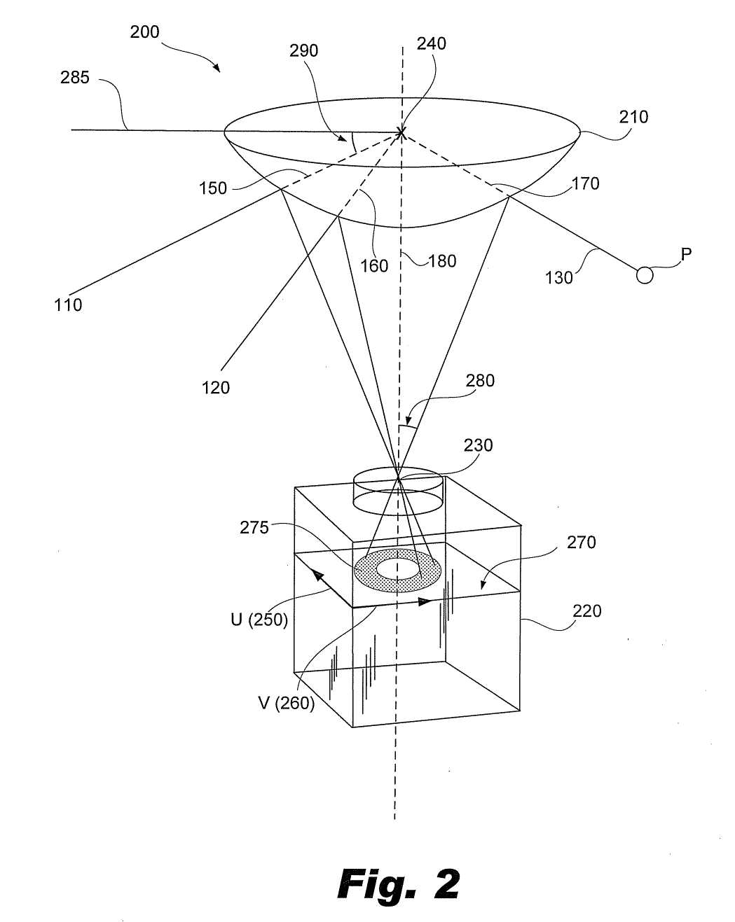

FIG. 2 shows a three dimensional representation of one embodiment of an omnidirectional imaging assembly (200) utilizing a hyperbolic mirror (210). The camera (220) and lens system are configured such that the camera's field-of-view substantially covers the hyperbolic mirror (210). In FIG. 2, the hyperbolic mirror (210) is placed above the camera (220). Placing the mirror (210) above the camera (220) provides an omnidirectional view that can include the horizon and ground objects closer to the camera. This orientation may be desirable when the camera is installed for surveillance of a perimeter. The opposite orientation, as shown in FIG. 1, includes imagery of a large portion of the area above the camera, which may be sky, a building, or the interior of a building.

As previously illustrated in FIG. 1, light rays from the surroundings (110, 120, and 130) are incident on the hyperbolic surface and reflect to a single focal point (230). The camera (220) is properly positioned relative to the focal point (230) and the imaged rays fall upon the focal plane (270) contained within the camera (220).

For any point P in the surrounding scene, the angle of incidence (290) of impinging light rays (110, 120, 130) is directly proportional to the camera's viewing angle (280). This results in a one-to-one correspondence between an object P and the location of the image of object P on the focal plane (270) as defined by the coordinates U (250) and axis V (260). The resulting image from the hyperbolic mirror when focused on the focal plane (270) of the camera fills an annular or donut shaped region (275).

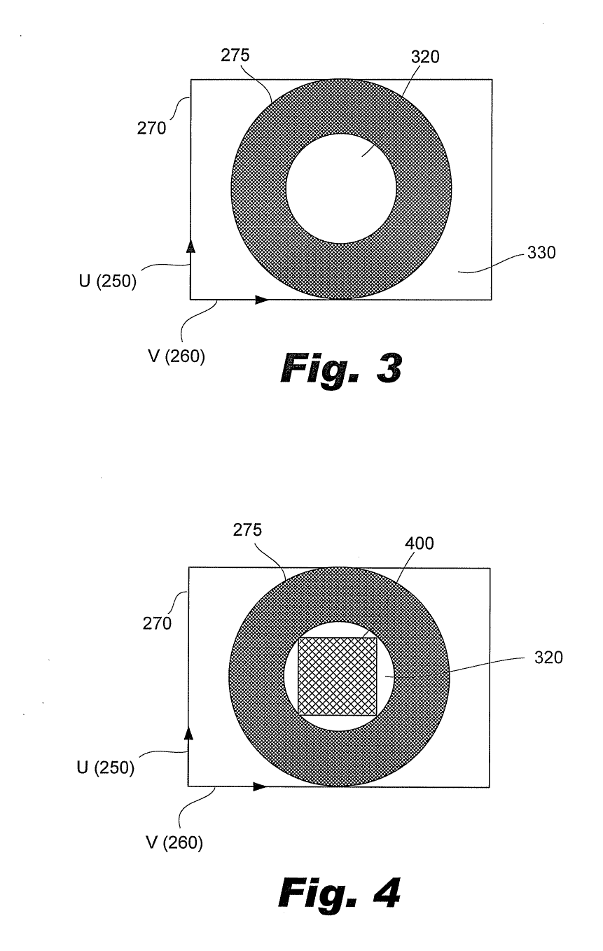

FIG. 3 is a top view of the focal plane (270) if the camera. The annular hashed area (275) represents a 360° omnidirectional view of the surroundings imaged onto the focal plan array (270) by the hyperbolic mirror (210) and camera lens system. Thus, the 360° omnidirectional image consumes only a portion of the pixels within the focal plane array. In particular, the unused center area (320) of the focal plane array (270) is not exploited by the omnidirectional imaging assembly (100, 200) described in FIGS. 1 and 2. In addition, there is an unused peripheral area (330) surrounding the annular image (310).

When a hyperbolic mirror (105, FIG. 1; 210, FIG. 2) is used as the reflecting surface in an omnidirectional imaging assembly, the highest spatial resolution is at the outer edge of the annular image. The images have increasing lower resolution in the portions of the image closer to the inner edge of the annulus (275). The increased resolution at the outer perimeter of the annular region (275) is advantageous because objects on the horizon are typically imaged on the outer perimeter. The objects on the horizon can be significantly more distant than other objects, and the increased resolution aids in detecting and identifying those distant objects.

Other configurations such as a conic mirror, parabolic mirror, spherical mirror or segmented mirror may be used. However, a single perspective point of view is not maintained. These alternative configurations may require additional image processing and contain a warped perspective or imaging stitching issue.

The center portion of the focal plane (320) is not used by the omnidirectional imaging system (100; FIG. 1; 200, FIG. 2) because the center of the hyperbolic mirror (105, FIG. 1; 210, FIG. 2) reflects back an image of the camera (140, 220) itself. In addition to unutilized pixels on the focal plane, a significant limitation of the omnidirectional imaging systems of FIGS. 1 and 2 is that a large angular field-of-view falls on a relatively small number of pixels. Thus, the angular field-of-view of each pixel is relatively large, resulting in a low resolution image. By way of example and not limitation, a low resolution image might only be able to provide a detailed image of an object at a very close range (for example, for objects that are closer than fifty feet). It can be difficult to classify a target at significantly greater distances (for example farther than 100 ft) due to the low resolution of the omnidirectional image.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

FIG. 4 shows one illustrative embodiment of a superimposed square region (400) residing in the center of the annular area (275) that represents an omnidirectional image from a curved reflector on the focal plane of a camera, as described above. The square region (400) represents a simultaneous narrow field-of-view imaged onto the previously unused center portion (320) of the focal plane (270) of the camera. This allows more efficient utilization of pixels on the focal plane (270). For example, the focal plane (270) may include a charge coupled device (CCD). Further, because the field-of-view that is imaged into the square (400) can be narrow (for example 15°, 6°, or 1.5°), the angular field-of-view of each pixel with the square region (400) is relatively small. This results in the ability to resolve detail in objects that subtend only a small angle in the 360° omnidirectional image. This is provides concurrent zoom. Concurrent zoom refers to the ability of an imaging system with a single focal plane to provide a detailed and magnified image within a narrow field-of-view while simultaneously providing an omnidirectional view.

In FIG. 4, the narrow field-of-view as imaged onto the focal plane is illustrated as a square (400) with a specific orientation. The narrow field-of-view may be imaged onto a focal plane in any shape or orientation. Further, as the optics that direct the concurrent zoom image onto the focal plane are adjusted, the image foot print and orientation on the focal plane may change.

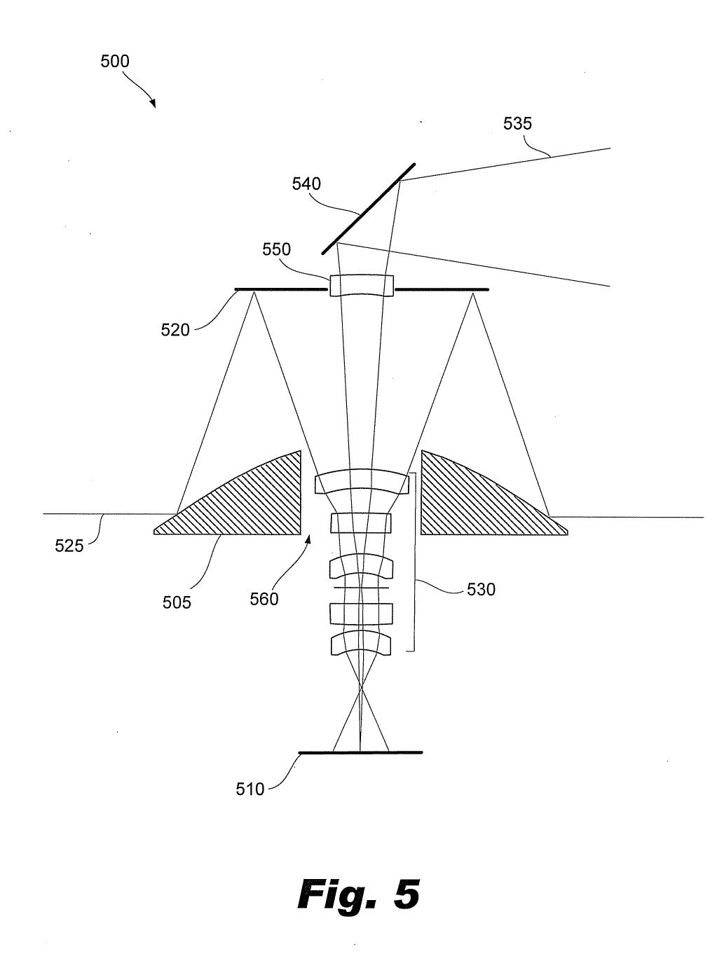

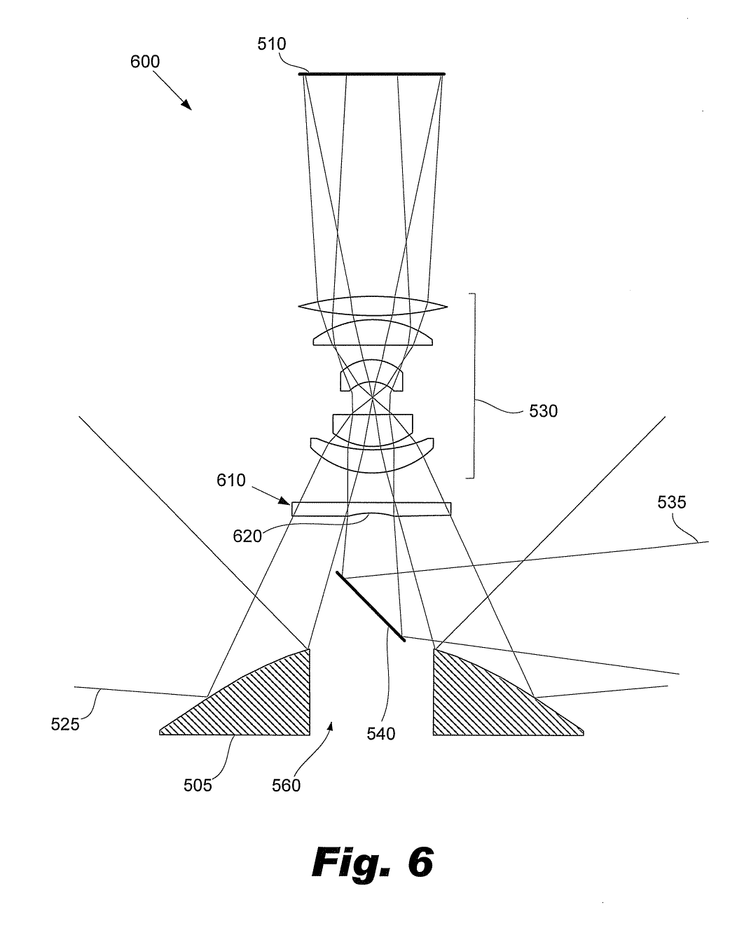

FIGS. 5 and 6 represent illustrative embodiments of omnidirectional imaging systems with concurrent zoom (500, 600) that include a hyperbolic mirror (505) and an imaging device containing a focal plane (510). The omnidirectional imaging systems with concurrent zoom (500, 600) provide a 360° omnidirectional view and a concurrent zoom using a single focal plane (510). As shown in FIG. 4, the omnidirectional imaging systems with concurrent zoom (500, 600) image the 360° omnidirectional view onto the focal plane (510) in an annular shape (275) and image the concurrent zoom into the center area (320) of the annulus.

As illustrated in FIG. 5, the omnidirectional imaging system with concurrent zoom (500) uses a hyperbolic mirror (505) to image the 360° omnidirectional image onto the focal plane (510). The configuration of the imaging system (500) allows material to be removed from the center of the hyperbolic mirror (505) to form a center aperture (560) without affecting the hyperbolic mirror's imaging function. The second field-of-view, or concurrent zoom, is imaged onto the center portion (320, FIG. 4) of the focal plane (510) through the center aperture (560). The hyperbolic mirror (505) still retains its single viewpoint (150, FIG. 1; 240, FIG. 2), while allowing a second field-of-view to be captured on the same focal plane through the central aperture (560).

The focal plane (510) may be housed in any suitable camera device, including off-the-shelf cameras with a standard lens system (530). The lens system (530) and focal plane (510) are configured such that the camera's field-of-view substantially covers the entire surface of the hyperbolic mirror (505). The omnidirectional light rays (525) from the surrounding scene are collected by the hyperbolic mirror (505) and reflected toward the folding mirror (520) to be reflected into the imaging lens assembly (530). The folding mirror (520), in addition to its role in allowing for a second field-of-view, folds the light rays such that a substantially more compact imaging system can be realized.

The narrow field-of-view is represented by light rays (535) that are collected by a pan/tilt mirror (540) and pass through a compensation focusing element (550) to be imaged by the same lens system (530). The compensation element (550) is located in the middle of the folding mirror (520).

The imaging lens assembly (530) focuses the incoming light rays (525, 535) onto the focal plane (510) within the camera. As previously discussed, the omnidirectional image is taken with an annular region (275, FIG. 4) of the focal plane (510). The narrow field-of-view rays fall within the center portion (320, FIG. 4) of the annulus (275, FIG. 4). This optical configuration results in a concurrent zoom view that more fully utilizes the pixels of focal plane (510).

This system generates a continuous 360° omnidirectional view of the surrounding area with a concurrent zoom that provides a second detailed view of a region of interest within the omnidirectional view. This second field-of-view is obtained without impacting the omnidirectional field-of-view. A single focal plane detects both images, with the concurrent zoom view being imaged on otherwise unused pixels. By more efficiently utilizing the pixels in the focal plane array, the cost of providing the additional concurrent zoom view is reduced. Further, the concurrent zoom is provided without the necessity of using a separate camera or focal plane which reduces the size, power consumption, and complexity of the system.

FIG. 6 shows another illustrative embodiment of an imaging system (600) that provides omnidirectional images with a concurrent zoom. The imaging system (600) is comprised of a hyperbolic mirror (505) with a central aperture (560), a pan/tilt mirror (540), a compensation element (610), a lens assembly (530) and focal plane (510). The lens assembly and focal plane can be housed in an off-the-shelf camera or custom designed if required.

The omnidirectional light rays (525) from the surroundings reflect off the hyperbolic surface of the mirror (505) and pass through the compensation element (610) and are collected by the lens assembly (530) to be imaged onto the focal plane (510). The narrow field-of-view light rays (535) reflect off the pan/tilt mirror (540) and pass through a central region (620) of the compensation element (610). The central region (620) has a different optical power than the surrounding portions of the compensation element (610) which the omnidirectional image passes through. This allows the narrow field-of-view light rays (535) to be imaged onto the focal plane (510) using the same lens assembly (530).

The systems illustrated in FIGS. 5 and 6 are representative embodiments of optical systems that are capable of capturing an omnidirectional image and a concurrent zoom image simultaneously. This capability allows a user to observe detail with a region of interest without changes in the omnidirectional view going unnoticed.

Design parameters that influence the concurrent zoom capability can be adapted to fit the specific situation or needs of the user. While one user may want a relatively wide field-of-view generated by the concurrent zoom, other users may be interested in a narrower field-of-view to classify and observe more distant targets. By way of example and not limitation, the field-of-view can be altered by changing the pan/tilt mirror size, optical distance between the pan/tilt mirror and the lens/camera system, or altering the characteristics of the lens system including the compensation element (550, FIG. 5; 610, FIG. 6). Still other users may be more concerned with the ability of the pan/tilt mirror to track targets moving at high velocities within 360° omnidirectional field-of-view. In these cases, the mechanical characteristics the mechanisms that control the motion of the pan/tilt mirror could be altered to yield high skew rates to facilitate the pan/tilt mirror maintaining the moving target within its field-of-view.

The light rays illustrated in FIGS. 1, 2, 5, and 6 are intended only as illustrations and not as mathematical representations of performance or actual physical behavior of light rays passing through the optical systems. Further, the optical surfaces, including the hyperbolic surface of the lens systems, are representative in nature only and are not intended to limit or restrict the invention. It will be appreciated by those of skill in the art that a wide variety of reflective surfaces could be utilized to direct light rays emanating from the surroundings into the lens system, including, but not limited to, conical, parabolic, segmented, spherical, or hyperbolic reflective surfaces.

Additionally a wide variety of lens materials and geometric configurations could be utilized to create the imaging lens assembly which focuses the light rays onto the focal plane. These imaging systems could be adapted to the specific circumstances or operating environment. For example, if long wavelength light was desired to be imaged, such as in night vision or lowlight situations, the lens assembly could be constructed of materials with indexes of refraction and transmissive properties that facilitate the imaging of a long wavelength light onto the focal plane.

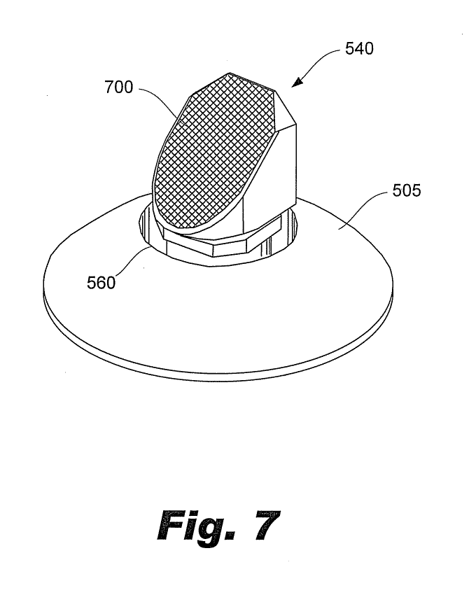

FIG. 7 illustrates a three dimensional perspective view of one illustrative embodiment of the hyperbolic mirror (505) with the pan/tilt mirror (540) being housed within the central aperture (560). In this embodiment, the central aperture (560) houses the support and actuation mechanisms that allow pan/tilt mirror (540) to be positioned and stabilized in the desired direction. The hash-marked area (700) represents the mirrored portion of the pan/tilt mirror (540) that reflects the narrow field-of-view light rays.

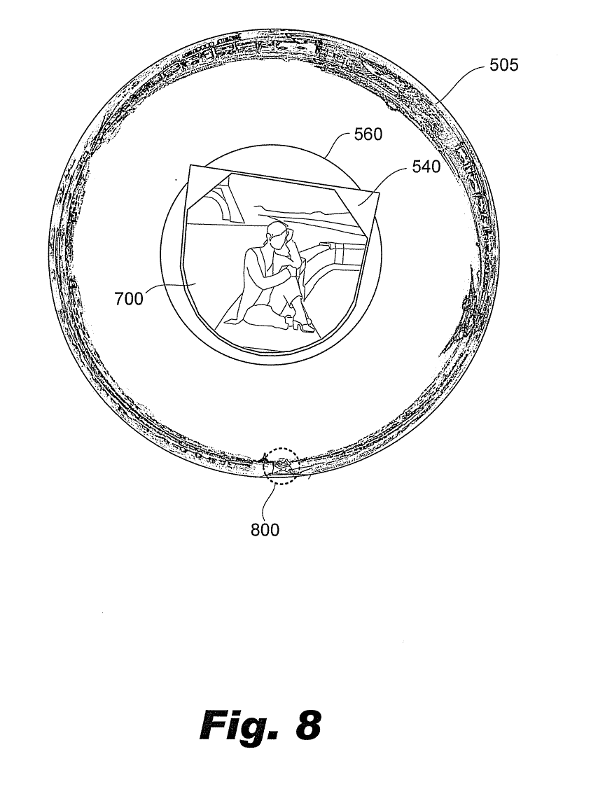

FIG. 8 illustrates a simulated scene as viewed by a focal plane array or an observer positioned above the illustrative hyperbolic mirror (505) and pan/tilt mirror (540) illustrated in FIGS. 6 and 7. The 360° omnidirectional view is reflected from the surface of the hyperbolic mirror (505). In this simulated image, the distorted images around the perimeter of the hyperbolic mirror (505) represent a surrounding urban scene. The majority of the objects within the scene are close to ground level and the light emanating from those objects is reflected in the outer perimeter of the hyperbolic mirror. Higher elevation objects such as taller buildings and objects in the sky are reflected correspondingly closer to the center of the hyperbolic mirror. In this instance, the large annular white region between the central aperture (560) and the darker ground-level objects is an image of the cloudless sky reflected in the hyperbolic mirror (505). As mentioned above, the outer perimeter of the hyperbolic image is imaged at a higher resolution than the center portion of the hyperbolic image.

A region of interest (800) is shown by a dotted circle. In practice, the user of the surveillance system would desire more information about objects within the region of interest, such as the entryway to a secured area, a person acting suspiciously, or a vehicle passing through the surrounding area. The user defines the region of interest within the omnidirectional view and adjusts the pan/tilt mirror to reflect light rays corresponding to the narrower field-of-view of the region of interest (800). This narrow field-of-view image is then reflected off the pan/tilt mirror (540, FIG. 6) and into the imaging lens system (530, FIG. 6) to be received by the focal plane array (510, FIG. 6). Thus, the annular image provides an omnidirectional view of the global scene, while the center image gives a detailed view of objects within the region of interest.

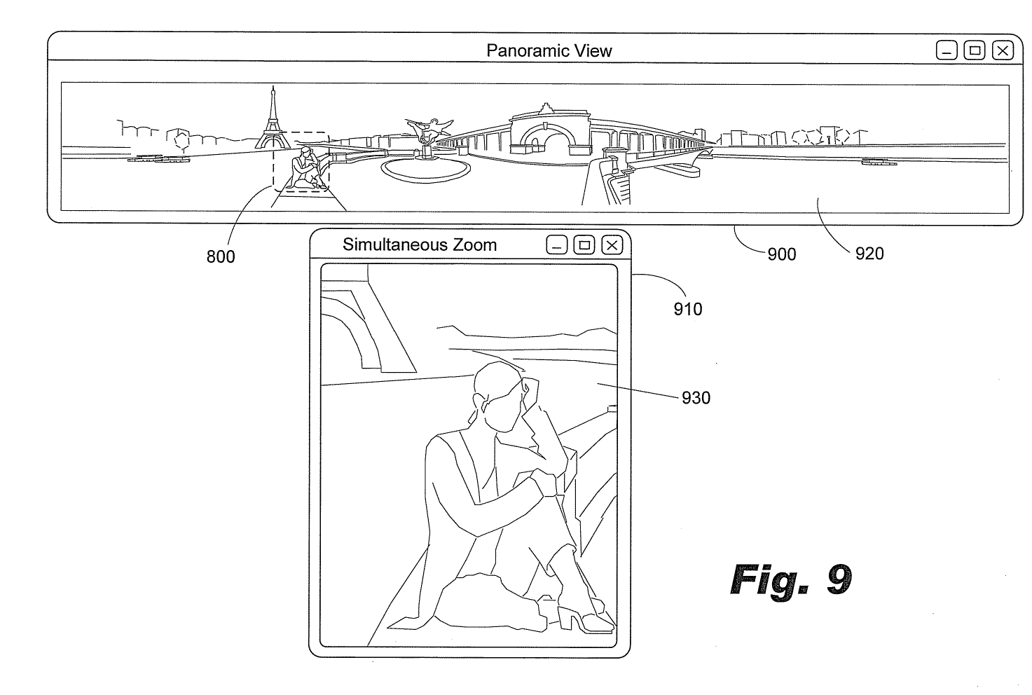

FIG. 9 illustrates an illustrative embodiment of a computer display of the surveillance imagery captured by an omnidirectional imaging system with concurrent zoom. The distorted imagery reflected off the hyperbolic mirror (505) onto the annular region of the focal plane (275) is processed or “unwrapped” to present a 360° panoramic view of the surrounding objects.

In one illustrative embodiment the “unwrapped” panoramic view (920) is displayed in a separate window (900). The user can select a region of interest (800) within the panoramic view in a variety of ways. By way of example and not limitation, the user could use a mouse to indicate a portion of the unwrapped panoramic view (920) which is of interest, or the user could key in specific coordinates that define a region of interest. Additionally, computer analysis of the panoramic view could identify threats or regions of interest. Once the region of interest (800) is identified, the pan/tilt mirror (540, FIG. 7) can be positioned to reflect light emanating from objects within the region of interest (800) into the imaging system. The selected region of interest (800) in the panoramic view (920) is shown by the area enclosed by the dotted line. The resulting concurrent zoom image (930) is simultaneously displayed within a separate window (910). In FIG. 9, the concurrent zoom is illustrated as having a relatively large field-of-view and a correspondingly low magnification. As discussed, above the magnification power and other characteristics of the concurrent zoom can be adapted to fit the specific needs of the user.

The omnidirectional imaging system with concurrent zoom as described above has a plurality of advantages over other systems. Because only a single focal plane and lens assembly are required, the size, power, cost, and mechanical complexity of this system are minimized.

Further, the hyperbolic mirror and pan/tilt mirror are capable of being used without modification over a wide spectral range. By way of example and not limitation, the hyperbolic mirror and pan/tilt unit could be coated to reflect light with wavelengths from 0.3μ to 20μ. Thus, by simply interchanging a visible camera for an infrared camera, the system can be used in low light and long wavelength applications. The only additional element that would need to be interchanged is the compensation element (550, 610). This significant versatility allows the spectral range of the omnidirectional imaging systems with concurrent zoom changed by coupling an off-the-shelf camera of the appropriate wavelength to the assembly. By way of example and not limitation, the omnidirectional imaging system with concurrent zoom could generate images a wide variety of wavelengths including ultraviolet, visible, near IR, mid-wave IR, and long-wave IR.

Additionally, a pair of omnidirectional imaging systems with concurrent zoom could be configured to generate three-dimensional images of the objects within the 360° field-of-view. Each system would obtain an independent perspective view of the surroundings. These independent perspective views could be combined to produce stereo images and quantitative three dimensional images of the surrounding scene.

Additionally, by utilizing the concurrent zoom capability of each of the systems, a binocular view could also be obtained. When both of the pan/tilt units are aimed toward the same region of interest, a binocular view comparable to human vision could be generated. This binocular view would allow more intuitive comprehension of dimensions and distances within the region of interest.

Further the dual field-of-view systems described above have relatively few moving parts. The only moving part within the system is the pan/tilt mirror which is actuated about two degrees of freedom. The pan/tilt mirror can be actuated in a wide variety of methods. By way of example and not limitation, the pan/tilt unit could be driven by direct drive motors, geared systems, hydraulic, pneumatic, or piezo drives.

A compact dual field-of-view system could have a significant impact on both military and commercial applications. For example, the system can be mounted on towers, submarines and ships, tanks, manned and unmanned airplanes, and battle vehicles for reliable panoramic threat detection, recognition, and classification. The cost of omnidirectional imaging systems with concurrent zoom is minimized by only using a single imaging sensor that provides simultaneous dual fields of view which include an instantaneous 360° omnidirectional view and a concurrent zoom. The system can be configured in a compact package, with hyperbolic mirror diameter being as small as a half-inch in diameter. Additionally because only a relatively small number of optical elements are required to simultaneously image the two fields-of-view onto the focal plane, the system has a high overall light throughput. This high overall light throughput that makes the system more efficient in utilizing light incident on the mirrors is particularly important in low light applications.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. An optical system configured to simultaneously image a first field-of-view and a second field-of-view on a single focal plane.

2. The optical system of claim 1 wherein said first field-of-view is an omnidirectional field-of-view.

3. The optical system of claim 2 wherein said second field-of-view is a concurrent narrow field-of-view.

4. The optical system of claim 3 wherein a first bundle of light rays emanating from said omnidirectional field-of-view is imaged onto a donut shaped area on said single focal plane.

5. The optical system of claim 4 wherein a second bundle of light rays emanating from said concurrent narrow field-of-view is imaged onto an unused central portion of said donut shaped area on said single focal plane.

6. The optical system of claim 5 wherein first bundle of light rays is directed to said single focal plane by a first reflective surface, said first reflective surface being chosen from the following: a substantially conical mirror, a mirror comprised of a plurality of flat segments, a substantially spherical mirror, a substantially parabolic mirror, and a substantially hyperbolic mirror.

7. The optical system of claim 6 wherein said first reflective surface comprises a hyperbolic mirror with a central aperture.

8. The optical system of claim 7 wherein said second bundle of light rays is directed to said focal plane by a second mirror.

9. The optical system of claim 8 wherein said second mirror further comprises a substantially planar mirror configured to be adjusted about at least one degree of freedom.

10. The optical system of claim 9 wherein said substantially planar mirror is configured to be adjusted about two degrees of freedom such that said concurrent field-of-view can be selected from substantially any subsection of said omnidirectional field-of-view.

11. The optical system of claim 10 further comprising a compensation element, wherein said second bundle of light rays is directed through said compensation element by said substantially planar mirror.

12. The optical system of claim 11 further comprising a third reflective surface, said first bundle of light rays being directed to said third reflective surface by said hyperbolic mirror.

13. The optical system of claim 12 wherein said first and second bundles of light rays pass through said central aperture.

14. The optical system of claim 11 wherein said first and second bundle of light rays pass through separate regions of said compensation element.

15. The optical system of claim 14 wherein support and adjust mechanisms coupled to said substantially planar mirror are at least partially contained within said central aperture.

16. An omni directional imaging system with concurrent zoom comprising:
a first reflective surface configured to reflect a first bundle of light rays such that extension of said first bundle of light rays are substantially coincident on a single view point;
a second reflective surface reflecting a second bundle of light rays, and
a camera with a field-of-view that substantially covers said first reflective surface and said second reflective surface, said camera being configured to generate image data signals.

17. The system of claim 16 wherein said first reflective surface comprises a substantially hyperbolic mirror, said substantially hyperbolic mirror having a first focal point, a second focal point, and a central aperture.

18. The system of claim 17 wherein said single view point is at said first focal point and said camera at said second focal point.

19. The system of claim 18 wherein said camera further comprises a focal plane, said light rays from said first field-of-view being imaged onto a donut shaped area on said focal plane.

20. The system of claim 19 wherein said light reflected by said second reflective surface is imaged onto a central area of said focal plane.

21. The system of claim 20 further comprising a processor coupled to said camera, said processor manipulating and displaying said image data signals as a panoramic view and a concurrent zoom view.

22. The system of claim 21 wherein said processor is additionally capable of adjusting said second reflective surface to correspond to a region of interest designated by a user.
